(19) United States
(12) Patent Application Publication
(10) Pub. No.: US 2019/0077498 A1
(43) Pub. Date: Mar. 14, 2019

(54) Aircraft Including Inclined Rotor Array

(71) Applicant: Korea Aerospace Research Institute, Daejeon (KR)

(72) Inventor: Myoung Jong YU, Daejeon (KR)

(21) Appl. No.: 16/102,268

(22) Filed: Aug. 13, 2018

(30) Foreign Application Priority Data
Sep. 12, 2017 (KR) 10-2017-0116688

(51) Int. Cl. B64C 15/02; B64C 39/02; B64D 31/06

(52) U.S. Cl. CPC B64C 15/02; B64C 39/024; B64C 2201/165; B64C 2201/024; B64C 2201/108; B64D 31/06

(57) ABSTRACT

Provided is an aircraft including an inclined rotor array, the aircraft including a body, a plurality of arms outwardly extending from the body, a plurality of rotors arranged on the arms, and a controller configured to control rotation speeds of the rotors, wherein the rotors inclined relative to the body are inclined based on a horizontal plane when the aircraft lands and the rotors are arranged on a first plane and a second plane.

### CROSS-REFERENCE TO RELATED APPLICATION(S)

This application claims the priority benefit of Korean Patent Application No. 10-2017-0116688 filed on Sep. 12, 2017, in the Korean Intellectual Property Office, the disclosure of which is incorporated herein by reference for all purposes.

### BACKGROUND

### 1. Field

One or more example embodiments relate to an aircraft including an inclined rotor array and, more particularly, to an aircraft including a plurality of rotors symmetrically arranged to be inclined relative to a body and mounted on an arm adjustable in length.

### 2. Description of Related Art

Aircrafts may include, for example, an airplane, an unmanned aerial vehicle, a helicopter, a balloon, and a glider.

Among the aircrafts, the unmanned aerial vehicle may be remotely manipulated using a radio wave without a human pilot aboard. The unmanned aerial vehicle may increase fuel efficiency and loading efficiency by reducing a volume and a weight. Also, the unmanned aerial vehicle may be used as a vehicle to carry out tasks in a dangerous area instead of people.

In recent years, with developments of technologies for manufacturing the unmanned aerial vehicle, costs have been reduced and an applicability has been increased. For this reason, the unmanned aerial vehicle is used for various purposes in many organizations such as global companies, information technology (IT) companies, and universities of engineering.

In general, multi-copter unmanned aerial vehicles may generate lift to take off the unmanned aerial vehicle using a plurality of rotors and change a thrust of a rotor to realize forward flight by maintaining or changing an attitude.

The unmanned aerial vehicle is disclosed in Korean Patent Application Publication No. 10-2016-0014266 filed on Jul. 29, 2014 and entitled as “DRONE.”

### SUMMARY

An aspect provides an aircraft including an inclined rotor array to reduce a yaw-axial rotation occurring during flight of the aircraft using a simple structure so that a flight stability increases.

Another aspect also provides an aircraft that includes an inclined rotor array and is capable of agile rotation.

Still another aspect also provides an aircraft including an inclined rotor array to save energy by reducing torque required during flight so that a time of flight is prolonged.

According to an aspect, there is provided an aircraft including an inclined rotor array, the aircraft including a body, a plurality of arms outwardly extending from the body, a plurality of rotors arranged on the arms, and a controller configured to control rotation speeds of the rotors, wherein the arms extend from the body to be inclined outwardly and upwardly or outwardly and downwardly such that the rotors are inclined, or the rotors are arranged to be inclined relative to the body, and wherein the rotors inclined relative to the body are inclined based on a horizontal plane when the aircraft lands and the rotors are arranged on a first plane and a second plane.

The rotors may include a first rotor disposed on the first plane, a second rotor disposed on the first plane and having a rotation axis parallel with a rotation axis of the first rotor, a third rotor disposed on the second plane and symmetrical to the second rotor based on the body, and a fourth rotor disposed on the second plane, having a rotation axis parallel with a rotation axis of the third rotor, and symmetrical to the first rotor based on the body.

A total amount of yaw-axial rotation torque of the aircraft may be obtained using the following equation: τₜₒₜₐₗ=(k_{τ} cos α+kb sin α)(ω₁²+ω₃²−ω₂²−ω₄²) in which τₜₒₜₐₗ denotes the total amount of yaw-axial rotation torque, k_{τ} is a constant for quasi-static maneuvering in free flight

over zero, k is a constant based on a design of the rotors, α is an angle of the rotors inclined relative to the body, b is a half of a distance between the first rotor and the fourth rotor and a half of a distance between the second rotor and the third rotor, ω₁ is an angular velocity of the first rotor, ω₂ is an angular velocity of the second rotor, ω₃ is an angular velocity of the third rotor, and ω₄ is an angular velocity of the fourth rotor, and the controller may be configured to set values of α and b based on a maximum amount of yaw-axial rotation torque of the aircraft.

In the equation, α may be less than or equal to 45 degrees.

The arms may be individually extended and contracted relative to the body such that a distance between each of the rotors and the body increases or decreases.

According to another aspect, there is also provided an aircraft including an inclined rotor array, the aircraft including a body, a plurality of arms having fixed angles relative to the body and extending outwardly, a plurality of rotors mounted on the arms to be inclined relative to the body, and a controller configured to control changes in length of the arms and torque of the rotors, wherein each of the arms includes a length adjusting member configured to adjust a length of the corresponding arm, and the length adjusting member is configured to extend and contract the corresponding arm such that distances between the body and the rotors are adjusted in response to the aircraft moving.

The rotors may be inclined based on a horizontal plane when the aircraft lands and symmetrically arranged on a first plane and a second plane symmetrical based on the body.

The rotors may include a first rotor, a second rotor, a third rotor, and a fourth rotor, a total amount of yaw-axial rotation torque of the aircraft may be obtained using the following equation: τₜₒₜₐₗ=k_{τ}(ω₁²+ω₃²−ω₂²−ω₄²)cos α+k(b₁ω₁²+b₂ω₃²−b₃ω₂²−b₄ω₄²)sin α in which τₜₒₜₐₗ denotes the total amount of yaw-axial rotation torque, k_{τ} is a constant for quasi-static maneuvering in free flight over zero, k is a constant based on a design of the rotors, α is an angle of the rotors inclined relative to the body, b₁ is a vertical distance from the first rotor to a symmetry plane between the first plane and the second plane, b₂ is a vertical distance from the second rotor to the symmetry plane, b₃ is a vertical distance from the third rotor to the symmetry plane, and b₄ is a vertical distance from the fourth rotor to the symmetry plane, ω₁ is an angular velocity of the first rotor, ω₂ is an angular velocity of the second rotor, ω₃ is an angular velocity of the third rotor, and ω₄ is an angular velocity of the fourth rotor, and the controller may be configured to extend and contract the length adjusting member based on a target amount of yaw-axial rotation torque of the aircraft.

The controller may be configured to control the length adjusting member to simultaneously extend and contract the arms such that the aircraft is sensitive to a control signal or insensitive to an external force.

The controller may be configured to individually control the length adjusting member included in each of the arms to increase torque in one direction of a yaw axis.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a perspective view illustrating an aircraft including an inclined rotor array according to an example embodiment;

FIG. 2 is a front view illustrating an aircraft including an inclined rotor array according to an example embodiment;

FIG. 3 is a diagram illustrating angles formed by an arm, an inclined rotor, and a body of an aircraft including an inclined rotor array according to an example embodiment;

FIG. 4 is a diagram illustrating a rotation direction of a rotor of an aircraft including an inclined rotor array according to an example embodiment;

FIG. 5 is a diagram illustrating a change in length of an arm of an aircraft including an inclined rotor array according to an example embodiment;

FIGS. 6A and 6B are diagrams illustrating a change in length of an arm for changing yaw-axial rotation torque in an aircraft including an inclined rotor array according to an example embodiment;

FIGS. 7A and 7B are diagrams illustrating a rotation of an aircraft including an inclined rotor array in response to a change in length of an arm of the aircraft according to an example embodiment; and

FIGS. 8A through 8E are diagrams illustrating a change in movement of an aircraft including an inclined rotor array based on torque of a rotor of the aircraft according to an example embodiment.

### DETAILED DESCRIPTION

Hereinafter, some example embodiments will be described in detail with reference to the accompanying drawings. Regarding the reference numerals assigned to the elements in the drawings, it should be noted that the same elements will be designated by the same reference numerals, wherever possible, even though they are shown in different drawings. Also, in the description of embodiments, detailed description of well-known related structures or functions will be omitted when it is deemed that such description will cause ambiguous interpretation of the present disclosure.

In addition, terms such as first, second, A, B, (a), (b), and the like may be used herein to describe components. Each of these terminologies is not used to define an essence, order or sequence of a corresponding component but used merely to distinguish the corresponding component from other component(s). It should be noted that if it is described in the specification that one component is “connected”, “coupled”, or “joined” to another component, a third component may be “connected”, “coupled”, and “joined” between the first and second components, although the first component may be directly connected, coupled or joined to the second component.

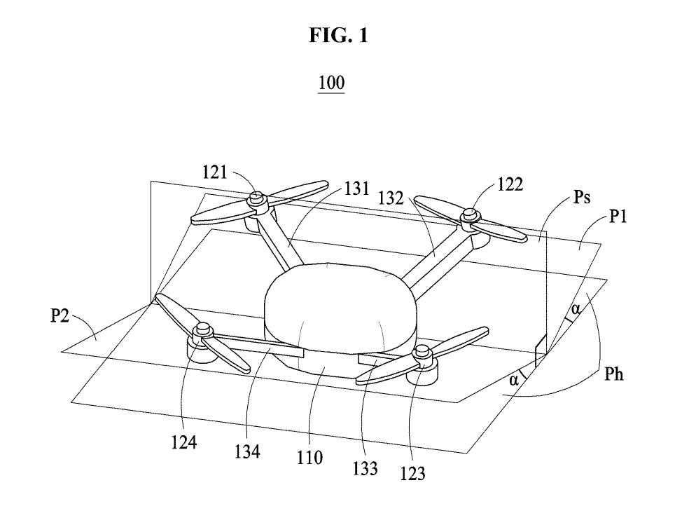

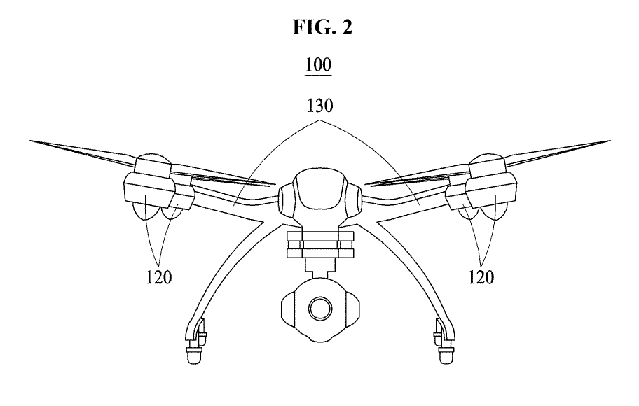

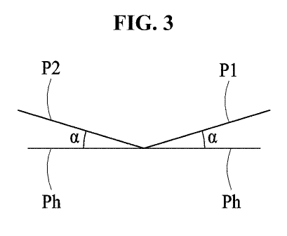

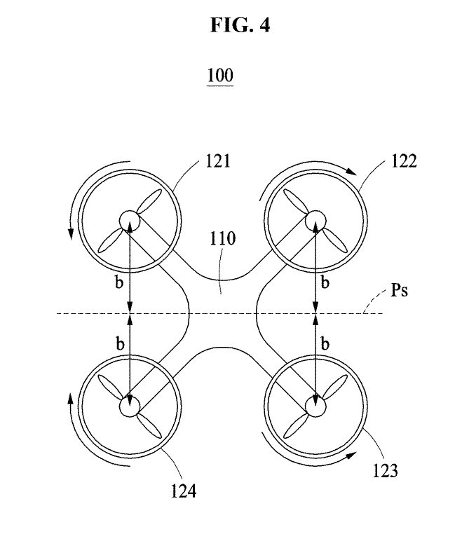

FIG. 1 is a perspective view illustrating an aircraft 100 including an inclined rotor array according to an example embodiment, FIG. 2 is a front view illustrating the aircraft 100 according to an example embodiment, FIG. 3 is a diagram illustrating angles formed by an arm 130, each rotor included in the inclined rotor array, and a body 110 of the aircraft 100 according to an example embodiment, and FIG. 4 is a diagram illustrating a rotation direction of a rotor of the aircraft 100 according to an example embodiment.

Referring to FIGS. 1 through 4, the aircraft 100 may include the body 110, a plurality of rotors 120, a plurality of arms 130, and a controller.

The body 110 may include various configurations, for example, a battery, a camera, or a cargo receiver depending on purposes and need of the aircraft 100.

The rotors 120 may be spaced apart from the body 110. The arms 130 may be arranged to connect the body 110 and the rotors 120.

Referring to FIG. 1, the arms 130 may extend outwardly from the body 110. The rotors 120, which mounted on the arms 130, may be arranged to be inclined relative to the body 110 with different directional thrusts.

Also, the arms 130 may be parallel with the body 110 or extended outwardly and upwardly or outwardly and downwardly at a fixed angle, so as to increase a structural stability. Likewise, the rotors 120 may be at a fixed angle relative to the body 110 or the arm 130 and thus, structurally stable.

Referring to FIGS. 1 through 3, the rotors 120 may be distributed on two virtual planes, for example, a first plane P1 and a second plane P2.

As illustrated in FIG. 1, the first plane P1 and the second plane P2 may be inclined by an angle α with respect to a horizontal plane Ph corresponding to a virtual plane. A same number of the rotors 120 may be arranged on the first plane P1 and the second plane P2. Also, a virtual plane Ps may be provided between the first plane P1 and the second plane P2. The virtual plane Ps may include a center of the body 110 and may be defined by a height directional axis of the body 110 and a width or length directional axis of the body 110. The first plane P1 and the second plane P2 may be symmetrically arranged based on the virtual plane Ps corresponding to a symmetrical plane. Hereinafter, the virtual plane Ps may also be referred to as, for example, a symmetrical plane Ps.

The rotors 120 may be symmetrically arranged based on the symmetrical plane Ps. Also, the rotors 120 may be arranged to be inclined relative to the body 110.

When the rotors 120 are symmetrically arranged on the first plane P1 and the second plane P2, a stability and an agility of the aircraft 100 may be increased in comparison to a case in which the rotors 120 are respectively arranged on planes or a case in which the rotors are arranged on a single plane.

The controller may individually control a rotation speed of each of the rotors 120.

Referring to FIG. 4, when the aircraft 100 is, for example, a quadrocopter, the rotors 120 may include a first rotor 121, a second rotor 122, a third rotor 123, and a fourth rotor 124. The first rotor 121 may be disposed on the first plane P1. The second rotor 122 may be disposed on the first plane P1 similarly to the first rotor 121. A rotation axis of the second rotor 122 may be parallel with a rotation axis of the first rotor 121 such that a thrust is generated in the same direction as the first rotor 121. The third rotor 123 may be disposed on the second plane P2 symmetrical with the first plane P1. The third rotor 123 may be plane-symmetrical with the second rotor 122. The fourth rotor 124 may be disposed on the second plane P2 similarly to the third rotor 123. A rotation axis of the fourth rotor 124 may be parallel with a rotation axis of the third rotor 123 such that a thrust is generated in the same direction as the third rotor 123.

Referring to FIGS. 1 and 2, the rotation axis of the first rotor 121 and the rotation axis of the second rotor 122 may be perpendicular to the first plane P1. Also, the rotation axis of the third rotor 123 and the rotation axis of the fourth rotor 124 may be perpendicular to the second plane P2.

A thrust direction of the first rotor 121 and the second rotor 122 may differ from a thrust direction of the third rotor 123 and the fourth rotor 124 by an angle of 2α.

When the aircraft 100 is the quadrocopter, a total amount of yaw-axial rotation torque τₜₒₜₐₗ of the aircraft 100 may be defined as shown in Equation 1 below.

τₜₒₜₐₗ=(k_{τ} cos α+kb sin α)(ω₁²+ω₃²−ω₂²−ω₄²)

In Equation 1, k_{τ} denotes a constant for quasi-static maneuvering in free flight and has a value greater than or equal to zero, and k denotes a constant varying based on a design of the rotors 120. α is an angle of the horizontal plane Ph relative to each of the first plane P1 and the second plane P2 on which the rotors 120 are arranged as shown in FIG. 3. b is a half of a distance between the first rotor 121 and the fourth rotor 124 and a half of a distance between the second rotor 122 and the third rotor 123 as shown in FIG. 4. ω₁ is an angular velocity of the first rotor 121, ω₂ is an angular velocity of the second rotor 122, ω₃ is an angular velocity of the third rotor 123, and ω₄ is an angular velocity of the fourth rotor 124. The controller may set values of α and b based on a maximum amount of yaw-axial rotation torque of the aircraft 100.

Equation 1 may be derived as described below.

When the quadrocopter includes the rotors 120 at an inclined angle α of zero, the total amount of yaw-axial rotation torque τₜ may be defined as shown in Equation 2 below.

τ₁=τ₁+τ₃−τ₂−τ₄=k_{τ}(ω₁²+ω₃²−ω₂²−ω₄²) [Equation 2]

In Equation 2, τ₁ denotes a torque of the first rotor 121, τ₂ denotes a torque of the second rotor 122, τ₃ denotes a torque of the third rotor 123, and τ₄ denotes a torque of the fourth rotor 124. “+” and “−” represent directions of the rotors.

When the rotors 120 are inclined at the inclined angle a, the total amount of yaw-axial rotation torque τₜₒₜₐₗ may be changed and defined as shown in Equation 3 below.

τₜₒₜₐₗ=(τ₁+τ₃−τ₂−τ₄)cos α+(F₁+F₃−F₂−F₄)b sin α [Equation 3]

In Equation 3, cos α denotes a change in torque value of each of the rotors 120 based on an angle between the body 110 and each of the rotors 120, and F, sin α, and b are a thrust generated due to an inclination of the rotors 120 and a rotor arrangement directional force of the thrust.

Equation 3 may also be expressed as follows.

$$\begin{matrix}{τ}_{total} = ( {τ}_{1} + {τ}_{3} - {τ}_{2} - {τ}_{4} ) cos α + \\ ( {F}_{1} + {F}_{3} - {F}_{2} - {F}_{4} ) b sin α \\ = {k}_{τ} ( {ω}_{1}^{2} + {ω}_{3}^{2} - {ω}_{2}^{2} - {ω}_{4}^{2} ) cos α + \\ k ( {ω}_{1}^{2} + {ω}_{3}^{2} - {ω}_{2}^{2} - {ω}_{4}^{2} ) b sin α \\ = ( {k}_{τ} cos α + k b sin α ) ( {ω}_{1}^{2} + {ω}_{3}^{2} - {ω}_{2}^{2} - {ω}_{4}^{2} )\end{matrix}$$

When the angle α is less than or equal to 45 degrees, a change amount of yaw-axial torque relative to an increased or decreased amount of angular velocity of the rotor 120 may increase as the angle α increases. Also, as a value of b that denotes a half of a distance between the first rotor 121 and the fourth rotor 124 and a half of a distance between the second rotor 122 and the third rotor 123, that is, a length of an arm increases, the changed amount of yaw-axial torque relative to the increased or decreased amount of angular velocity of the rotor 120 may increase.

Thus, the inclined arrangement of the rotors 120 may increase an efficiency of yaw-axial torque of the aircraft 100 generated based on a rotation speed of the rotors 120.

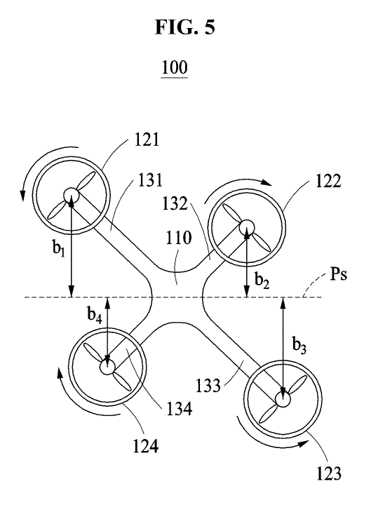

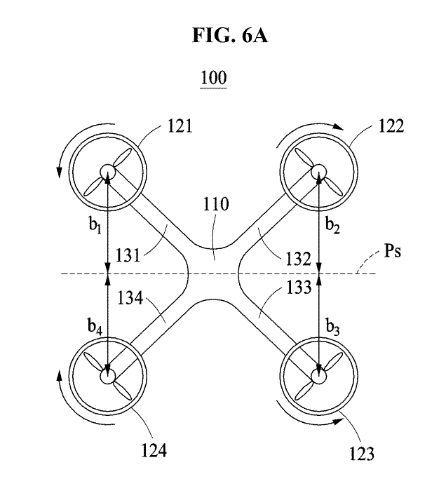

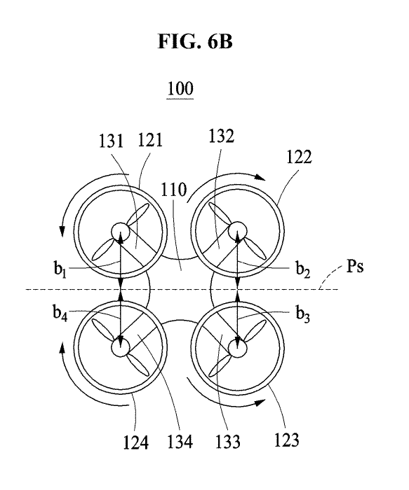

FIG. 5 is a diagram illustrating a change in length of the arm 130 of the aircraft 100 including an inclined rotor array according to an example embodiment, and FIGS. 6A and 6B are diagrams illustrating a change in length of the arm 130 for changing yaw-axial rotation torque in the aircraft 100 including an inclined rotor array according to an example embodiment. Referring to FIG. 5, when the aircraft 100 is a quadrocopter, the arms 130 may include a first arm 131, a second arm 132, a third arm 133, and a fourth arm 134. The first arm 131 may be connected to the first rotor 121, the second arm 132 may be connected to the second rotor 122, the third arm 133 may be connected to the third rotor 123, and the fourth arm 134 may be connected to the fourth rotor 124.

FIG. 5 illustrates a state in which lengths of the first arm 131 and the third arm 133 are increased and a state in which lengths of the second arm 132 and the fourth arm 134 are reduced.

Referring to FIGS. 5 through 6B, each of the first arm 131, the second arm 132, the third arm 133, and the fourth arm 134 may include a length adjusting member that adjusts a length of the corresponding arm. The length adjusting member may be individually or uniformly controlled by a controller. Each of the arms 130 may be individually or uniformly changed in length, so that the first arm 131, the second arm 132, the third arm 133, and the fourth arm 134 may increase or reduce distances between the body 110 and the first rotor 121, the second rotor 122, the third rotor 123, and the fourth rotor 124.

When the aircraft 100 is the quadrocopter, the total amount of yaw-axial rotation torque τₜₒₜₐₗ of the aircraft 100 may be defined as shown in Equation 4 below.

τₜₒₜₐₗ=k_{τ}(ω₁²+ω₃²−ω₂²−ω₄²)cos α+k(b₁ω₁²+b₂ω₃²−b₃ω₂²−b₄ω₄²)sin α [Equation 4]

In Equation 4, b₁ denotes a vertical distance from the first rotor 121 to the symmetrical plane Ps between the first plane P1 and the second plane P2, b₂ denotes a vertical distance from the second rotor 122 to the symmetrical plane Ps, b₃ denotes a vertical distance from the third rotor 123 to the symmetrical plane Ps, and b₄ denotes a vertical distance from the fourth rotor 124 to the symmetrical plane Ps.

Referring to FIGS. 5 through 6B, the vertical distances b₁, b₂, b₃, and b₄ may change in response to the lengths of the arms increasing or decreasing. When the length of the first arm 131 increases, the distance between the first rotor 121 and the body 110 may increase and thus, the vertical distance bi from the first arm 131 may also increase. When the vertical distance bi increases, a total amount of torque generated relative to an angular velocity of the first rotor 121 may increase. As such, when the length of the arm 130 increases, torque may increase such that an increased amount of torque is greater than an increased amount of angular velocity of the rotor 120.

Thus, the controller may increase a yaw-axial torque efficiency by controlling the lengths of the arms 130.

Referring to FIG. 6A, each of the first arm 131, the second arm 132, the third arm 133, and the fourth arm 134 may be in a state in which a length is increased. When the lengths of the first arm 131, the second arm 132, the third arm 133, and the fourth arm 134 increase, a yaw-axial rotation of the aircraft 100 relative to a rotation speed of each of the rotors 120 may more sensitively react. Referring to FIG. 6B, each the first arm 131, the second arm 132, the third arm 133, and the fourth arm 134 may be in a state in which the length is decreased. When the lengths of the first arm 131, the second arm 132, the third arm 133, and the fourth arm 134 are decreased, the yaw-axial rotation of the aircraft 100 relative to the rotation speed of each of the rotors 120 may more insensitively react.

Also, the controller may individually or simultaneously control the lengths of the arms 130 such that the yaw-axial rotation of the aircraft 100 due to an external force such as wind is reduced.

Specifically, the lengths of the arms 130 may be individually controlled such that the aircraft 100 agilely rotates in response to an adjustment signal. Also, the controller may individually control the lengths of the arms to increase a rotational power of the aircraft 100 in one yaw-axial direction.

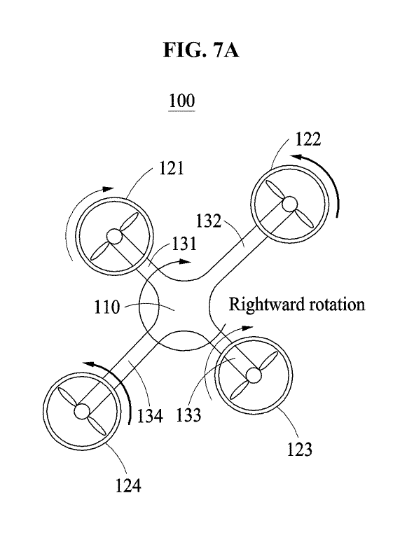

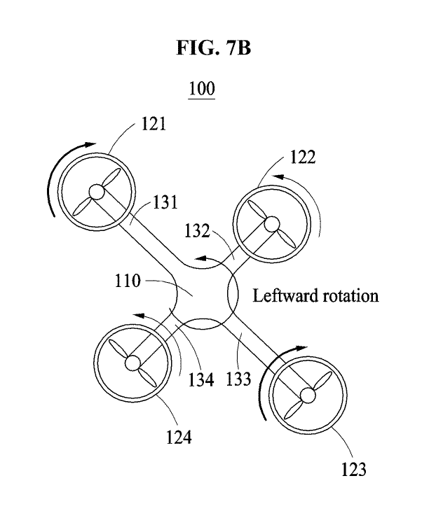

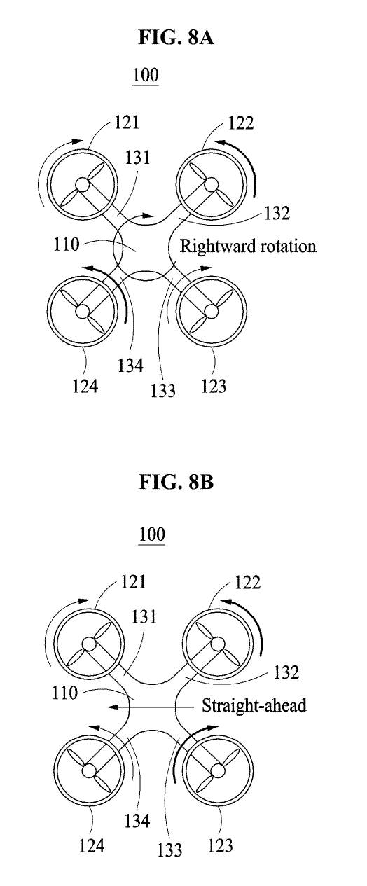

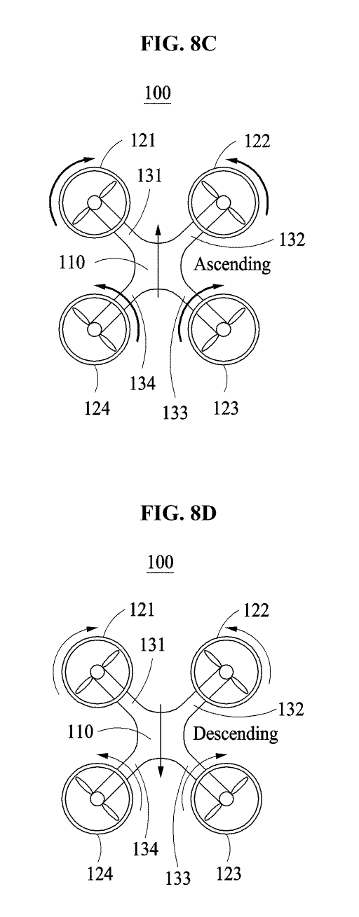

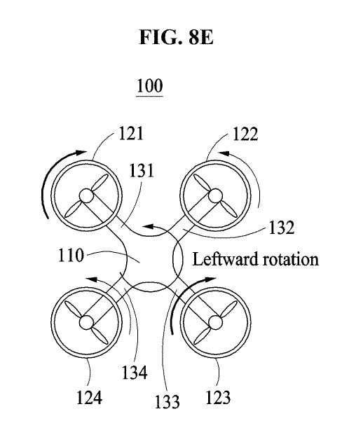

Such control method will be described in detail with reference to FIGS. 7A through 8E.

FIGS. 7A and 7B are diagrams illustrating a rotation of the aircraft 100 including an inclined rotor array in response to a change in length of the arm 130 of the aircraft 100 according to an example embodiment.

FIG. 7A illustrates a change in length of the arms 130 and a change in torque of the rotors 120 based on a rightward rotation of the aircraft 100 including the inclined rotor array, and FIG. 7B illustrates a change in length of the arms 130 and a change in torque of the rotors 120 based on a leftward rotation of the aircraft 100 including the inclined rotor array.

In FIGS. 7A and 7B, arrows represent rotation directions of the rotors 120 and widths of the arrows reflect rotation speeds of the rotors 120. As the width of the arrow increases, the rotation speed of the rotor may be relatively large. As the width of the arrow decreases, the rotation speed of the rotor may be relatively small.

Referring to FIG. 7A, when the aircraft 100 generates rightward yaw-axis rotational power, the controller may control the arms 130 such that distances between the body 110 and the first rotor 121 and the third rotor 123 rotating in a clockwise direction are greater than distances between the body 110 and the second rotor 122 and the third rotor 124 rotating in a counterclockwise direction. Because rotational power generated by each of the rotors 120 increases proportionally to the lengths of the arms 130, the distances between the body 110 and the first rotor 121 and the third rotor 123 rotating in the clockwise direction may need to increase to increase the rightward rotation of the aircraft 100.

Specifically, the length of the first arm 131 may increase such that the distance between the body 110 and the first rotor 121 rotating in the clockwise direction increases. Likewise, the length of the third arm 133 may increase such that the distance between the body 110 and the third rotor 123 rotating in the clockwise direction increases. Also, the length of the second arm 132 may be reduced such that the distance between the body 110 and the second rotor 122 rotating in the counterclockwise direction decreases. Likewise, the length of the fourth arm 134 may be reduced such that the distance between the body 110 and the fourth rotor 124 rotating in the counterclockwise direction decreases.

Also, to increase the rightward yaw-axis rotational power of the aircraft 100, the controller may control the rotation speeds of the first rotor 121 and the third rotor 123 to be greater than the rotation speeds of the second rotor 122 and the fourth rotor 124.

Referring to FIG. 7B, when the aircraft 100 generates leftward yaw-axis rotational power, the controller may control the arms 130 such that the distances between the body 110 and the second rotor 122 and the third rotor 124 rotating in the counterclockwise direction are greater than the distances between the body 110 and the first rotor 121 and the third rotor 123 rotating in the clockwise direction.

Specifically, the length of the second arm 132 may increase such that the distance between the body 110 and the second rotor 122 rotating in the counterclockwise direction increases. Likewise, the length of the fourth arm 134 may increase such that the distance between the body 110 and the fourth rotor 124 rotating in the counterclockwise direction increases. Also, the length of the first arm 131 may be reduced such that the distance between the body 110 and the first rotor 121 rotating in the clockwise direction decreases. Likewise, the length of the third arm 133 may be reduced such that the distance between the body 110 and the third rotor 123 decreases.

Also, to increase the leftward yaw-axis rotational power of the aircraft 100, the controller may control the rotation speeds of the second rotor 122 and the fourth rotor 124 to be greater than the rotation speeds of the first rotor 121 and the third rotor 123.

FIGS. 8A through 8E illustrate examples of a change in torque of the rotors 120 based on a movement of the aircraft 100 including an inclined rotor array.

FIG. 8A illustrates a rotation speed of each of the rotors 120 changing when the aircraft 100 turns right, FIG. 8B illustrates a rotation speed of each of the rotors 120 changing when the aircraft 100 is driven straight ahead in one direction, FIG. 8C illustrates a rotation speed of each of the rotors 120 changing when the aircraft 100 ascends, FIG. 8D illustrates a rotation speed of each of the rotors 120 changing when the aircraft 100 lands, and FIG. 8E illustrates a rotation speed of each of the rotors 120 changing when the aircraft 100 turns left.

Referring to FIG. 8A, to rightwardly rotate the aircraft 100, a controller may control rotation speeds of the second rotor 122 and the fourth rotor 124 rotating in a counterclockwise direction to be greater than rotation speeds of the first rotor 121 and the third rotor 123 rotating in a clockwise direction. Referring to FIG. 8B, to drive the aircraft 100 straight, the controller may relatively increase or reduce the rotation speeds of the first rotor 121 and the fourth rotor 124 disposed in plane-symmetrical position and having rotation directions opposite to each other, or the rotation speeds of the second rotor 122 and the third rotor 123 disposed in plane-symmetrical position and having rotation directions opposite to each other. Referring to FIGS. 8C and 8D, the controller may increase or reduce the rotation speeds of the rotors 120 such that the aircraft 100 ascends or descends. Referring to FIG. 8E, to leftwardly rotate the aircraft 100, the controller may control the rotation speeds of the first rotor 121 and the third rotor 123 rotating in the clockwise direction to be greater than the rotation speeds of the second rotor 122 and the fourth rotor 124 rotating in the counterclockwise direction.

According to the aspects of the aircraft 100 described herein, the aircraft 100 may increase a flight stability by reducing or cancelling a yaw-axial rotation occurring due to an external force during flight, increase rotational power of the aircraft 100 to agilely rotate, and save energy by reducing torque required for rotation during the flight.

According to example embodiments, it is possible to provide an aircraft including an inclined rotor array to reduce a yaw-axial rotation occurring during flight of the aircraft using a simple structure so that a flight stability increases.

According to example embodiments, it is possible to provide an aircraft that includes an inclined rotor array and is capable of agile rotation.

According to example embodiments, it is possible to provide an aircraft including an inclined rotor array to save energy by reducing torque required during flight so that a time of flight is prolonged.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An aircraft including an inclined rotor array, the aircraft comprising:
a body;
a plurality of arms outwardly extending from the body;
a plurality of rotors arranged on the arms; and
a controller configured to control rotation speeds of the rotors,
wherein the arms extend from the body to be inclined outwardly and upwardly or outwardly and downwardly such that the rotors are inclined, or the rotors are arranged to be inclined relative to the body, and
wherein the rotors inclined relative to the body are inclined based on a horizontal plane when the aircraft lands and the rotors are arranged on a first plane and a second plane.

2. The aircraft of claim 1, wherein the rotors include:
a first rotor disposed on the first plane;
a second rotor disposed on the first plane and having a rotation axis parallel with a rotation axis of the first rotor;
a third rotor disposed on the second plane and symmetrical to the second rotor based on the body; and
a fourth rotor disposed on the second plane, having a rotation axis parallel with a rotation axis of the third rotor, and symmetrical to the first rotor based on the body.

3. The aircraft of claim 2, wherein a total amount of yaw-axial rotation torque of the aircraft is obtained using the following equation:
τₜₒₜₐₗ=(k_{τ} cos α+kb sin α)(ω₁²+ω₃²−ω₂²−ω₄²)
in which τₜₒₜₐₗ denotes the total amount of yaw-axial rotation torque, k_{τ} is a constant for quasi-static maneuvering in free flight and has a value greater than zero, k is a constant based on a design of the rotors, α is an angle of the rotors inclined relative to the body, b is a half of a distance between the first rotor and the fourth rotor and a half of a distance between the second rotor and the third rotor, ω₁ is an angular velocity of the first rotor, ω₂ is an angular velocity of the second rotor, ω₃ is an angular velocity of the third rotor, and ω₄ is an angular velocity of the fourth rotor, and
the controller is configured to set values of α and b based on a maximum amount of yaw-axial rotation torque of the aircraft.

4. The aircraft of claim 3, wherein, in the equation, α is less than or equal to 45 degrees.

5. The aircraft of claim 1, wherein the arms are individually extended and contracted relative to the body such that a distance between each of the rotors and the body increases or decreases.

6. An aircraft including an inclined rotor array, the aircraft comprising:
a body;
a plurality of arms having fixed angles relative to the body and extending outwardly;
a plurality of rotors mounted on the arms to be inclined relative to the body; and
a controller configured to control changes in length of the arms and torque of the rotors,
wherein each of the arms includes a length adjusting member configured to adjust a length of the corresponding arm, and
the length adjusting member is configured to extend and contract the corresponding arm such that distances between the body and the rotors are adjusted in response to the aircraft moving.

7. The aircraft of claim 6, wherein the rotors are inclined based on a horizontal plane when the aircraft lands and symmetrically arranged on a first plane and a second plane symmetrical based on the body.

8. The aircraft of claim 7, wherein the rotors include a first rotor, a second rotor, a third rotor, and a fourth rotor,
a total amount of yaw-axial rotation torque of the aircraft is obtained using the following equation:
τₜₒₜₐₗ=k_{τ}(ω₁²+ω₃²−ω₂²−ω₄²)cos α+k(b₁ω₁²+b₂ω₃²−b₃ω₂²−b₄ω₄²)sin α
in which τₜₒₜₐₗ denotes the total amount of yaw-axial rotation torque, k_{τ} is a constant for quasi-static maneuvering in free flight and has a value greater than zero, k is a constant based on a design of the rotors, α is an angle of the rotors inclined relative to the body, b₁ is a vertical distance from the first rotor to a symmetry plane between the first plane and the second plane, b₂ is a vertical distance from the second rotor to the symmetry plane, b₃ is a vertical distance from the third rotor to the symmetry plane, and b₄ is a vertical distance from the fourth rotor to the symmetry plane, ω₁ is an angular velocity of the first rotor, ω₂ is an angular velocity of the second rotor, ω₃ is an angular velocity of the third rotor, and ω₄ is an angular velocity of the fourth rotor, and
the controller is configured to extend and contract the length adjusting member based on a target amount of yaw-axial rotation torque of the aircraft.

9. The aircraft of claim 6, wherein the controller is configured to control the length adjusting member to simultaneously extend and contract the arms such that the aircraft is sensitive to a control signal or insensitive to an external force.

10. The aircraft of claim 6, wherein the controller is configured to individually control the length adjusting member included in each of the arms to increase torque in one direction of a yaw axis.
